(19) United States
(12) Patent Application Publication
(10) Pub. No.: US 2025/0226779 A1
(43) Pub. Date: Jul. 10, 2025

(54) INVERTER CONTROL DEVICE AND INVERTER CONTROL METHOD

(71) Applicant: Hanon Systems, Daejeon (KR)

(72) Inventors: Young Jin Kim, Daejeon (KR); Won Seok Kim, Daejeon (KR); Eui Hyun Kim, Daejeon (KR); Ji Won Kim, Daejeon (KR); Seok Ho Shin, Daejeon (KR); Ho Sung Jang, Daejeon (KR); Byoung Su Lee, Daejeon (KR)

(21) Appl. No.: 19/014,649

(22) Filed: Jan. 9, 2025

(30) Foreign Application Priority Data
Jan. 9, 2024 (KR) 10-2024-0003788

(51) Int. Cl. H02P 21/22; H02P 21/18

(52) U.S. Cl. CPC H02P 21/22; H02P 21/18

(57) ABSTRACT

An inverter control device and an inverter control method. The inverter control device for controlling a motor based on speed feedback while the motor is operating includes: a motor speed estimation unit configured to estimate a speed of the motor and output an estimated motor speed; a speed controller configured to output a speed control signal based on a reference speed and the estimated motor speed; and a current command generator configured to output a current command corresponding to the speed control signal and the estimated motor speed, based on a previously generated current command lookup table.

### CROSS REFERENCE TO RELATED PATENT APPLICATIONS

This patent application claims the benefit of and priority to Korea Patent Application No. 10-2024-0003788, filed on Jan. 9, 2024, the entire contents of which are incorporated herein by reference for all purposes.

### FIELD

The disclosure relates to an inverter control device and an inverter control method of an electric compressor.

### BACKGROUND

Recently, research on electric and hybrid vehicles has been actively conducted due to environmental issues. The electric and hybrid vehicles use a driving force of an electric motor, and include an inverter to control the electric motor. Further, the electric and hybrid vehicles use an electric compressor to drive an air conditioning system, and includes an inverter to control a motor of the electric compressor.

The electric compressor uses an interior permanent magnet synchronous motor (IPMSM), which is advantageous to increase high power density and to reduce weight. In this case, maximum torque per ampere (MTPA) control is possible through appropriate phase current commands (d-axis, q-axis commands).

Conventionally, motor control has been performed through logic that generates a current command for the MTPA control. However, this method has problems of requiring a lot of calculation time and requiring additional logic for field-weakening control in areas where the field-weakening control is performed for high-speed operation of the motor.

### SUMMARY

An aspect of the disclosure is to provide an inverter control device and an inverter control method, which do not require high calculation speed.

Another aspect of the disclosure is to provide an inverter control device and an inverter control method, which use fewer software resources.

Still another aspect of the disclosure is to provide an inverter control device and an inverter control method, which have low manufacturing costs.

Still another aspect of the disclosure is to provide an inverter control device and an inverter control method, which have simple control logic.

The aspects of the disclosure are not limited to the technical aspects mentioned above, and other technical aspects not mentioned above will be clearly understood by those skilled in the art from the following descriptions.

According to an embodiment, an inverter control device for controlling a motor based on speed feedback while the motor is operating includes: a motor speed estimation unit configured to estimate a speed of the motor and output an estimated motor speed; a speed controller configured to output a speed control signal based on a reference speed and the estimated motor speed; and a current command generator configured to output a current command corresponding to the speed control signal and the estimated motor speed, based on a previously generated current command lookup table.

The current command generator may generate the current command lookup table, comprising current command values for maximum torque per ampere (MTPA) control, based on current limit value, voltage limit value, and torque equation of the motor.

The current command lookup table may comprise a d-axis current command lookup table and a q-axis current command lookup table.

The d-axis current command lookup table and The q-axis current command lookup table may comprise current command values, which are added offset to the current command values for MTPA control, for field-weakening control.

The current command generator may output a d-axis current command based on the d-axis current command lookup table, and outputs a q-axis current command based on the q-axis current command lookup table.

The inverter control device may further comprise a first current coordinate converter configured to convert three-phases currents supplied from the inverter to the motor into an alpha axis current and a beta axis current, a second current coordinate converter configured to convert the alpha axis current and the beta axis current to a d-axis current and a q-axis current, a current PI controller configured to generate a d-axis voltage command based on the d-axis current command and the d-axis current and a q-axis voltage command based on the q-axis current command and the q-axis current, a voltage coordinate converter configured to convert the d-axis voltage command and q-axis voltage command into an alpha-axis voltage command and a beta-axis voltage command; and a space vector modulator configured to modulate the alpha-axis voltage command and the beta-axis voltage command into a space vector.

The motor speed estimation unit may estimate a rotor position and a rotor speed of the motor based on the d-axis voltage command, the q-axis voltage command, the d-axis current and the q-axis current.

The rotor position is provided to the second current coordinate converter in order to be used for converting the alpha axis current and the beta axis current to the d-axis current and the q-axis current.

The rotor position is provided to the voltage coordinate converter in order to be used for converting the d-axis voltage command and q-axis voltage command into an alpha-axis voltage command and a beta-axis voltage command.

According to an embodiment, an inverter control method includes estimating a speed of a motor and outputting an estimated motor speed, outputting a speed control signal based on a reference speed and the estimated motor speed and outputting a current command corresponding to the speed control signal and the estimated motor speed, based on a previously generated current command lookup table.

The inverter control method may further include generating the current command lookup table, comprising current command values for maximum torque per ampere (MTPA) control, based on current limit value, voltage limit value, and torque equation of the motor.

The generating the current command lookup table may include generating a d-axis current command lookup table and a q-axis current command lookup table.

The d-axis current command lookup table and the q-axis current command lookup table may comprise current command values, which are added offset to the current command values for MTPA control, for field-weakening control.

The outputting the current command may comprise outputting a d-axis current command based on the d-axis current command lookup table and a q-axis current command based on the q-axis current command lookup table.

The inverter control method may further include converting three-phases currents supplied from the inverter to the motor into an alpha axis current and a beta axis current, converting the alpha axis current and the beta axis current to a d-axis current and a q-axis current, generating a d-axis voltage command based on the d-axis current command and the d-axis current and a q-axis voltage command based on the q-axis current command and the q-axis current, converting the d-axis voltage command and q-axis voltage command into an alpha-axis voltage command and a beta-axis voltage command and modulating the alpha-axis voltage command and the beta-axis voltage command into a space vector.

The estimating a speed of a motor may include estimating a rotor position and a rotor speed of the motor based on the d-axis voltage command, the q-axis voltage command, the d-axis current and the q-axis current.

The inverter control method may further include providing the rotor position to a second current coordinate converter in order to be used for converting the alpha axis current and the beta axis current to the d-axis current and the q-axis current and providing the rotor position to a voltage coordinate converter in order to be used for converting the d-axis voltage command and q-axis voltage command into an alpha-axis voltage command and a beta-axis voltage command.

Other details of the disclosure are included in the detailed description and the accompanying drawings.

### BRIEF DESCRIPTION OF THE DRAWINGS

FIG. 1 is a diagram showing a configuration of an inverter control device according to an embodiment.

FIG. 2 is a diagram showing an MTPA lookup table according to an embodiment.

FIG. 3 is a diagram showing a current command generator according to an embodiment.

FIG. 4 is a flowchart showing an inverter control method according to an embodiment.

### DETAILED DESCRIPTION

Regarding embodiments disclosed in this specification, the specific structural or functional description is merely illustrative for the purpose of describing the embodiments, and embodiments of the disclosure may be implemented in various forms but not be limited to the embodiments set forth in this specification.

Because the embodiments of the disclosure may be variously modified and have various forms, embodiments will be illustrated in the drawings and described in detail in this specification. However, it should be understood that embodiments of the disclosure are intended not to be limited to the specific embodiments but to cover all modifications, equivalents or alternatives without departing from the spirit and technical scope of the disclosure.

Terms such as “first” or “second” are used herein merely to describe a variety of elements, but the elements are not limited by these terms. Such terms are used only for the purpose of distinguishing one element from another element. For example, without departing from the scope of the disclosure, a first element may be referred to as a second, and vice versa.

When a certain element is referred to as being “connected to” or “coupled to” another element, it will be understood that they may be directly connected to or coupled to each other but or intervening elements may be present therebetween. On the other hand, when a certain element is referred to as being “directly connected to” or “directly coupled to” another element, it will be understood that no intervening elements are present therebetween. Other expressions describing relationships between elements, such as “between,” “immediately between,” “adjacent to,” “directly adjacent to,” or etc. may also be construed in the same manner.

Terms used in this specification are merely used for explaining specific embodiments, but not intended to limit the disclosure. Unless the context clearly dictates otherwise, singular forms include plural forms as well.

It is to be understood that terms “include,” “have,” etc. as used herein specify the presence of stated features, integers, steps, operations, elements, components, or combination thereof, but do not preclude the presence or addition of one or more other features, integers, steps, operations, elements, components or combination thereof.

Unless defined otherwise, all terms used herein including technical or scientific terms have the same meanings as those generally understood by a person having ordinary knowledge in the art to which the disclosure pertains.

The terms such as those defined in generally used dictionaries are construed to have meanings matching that in the context of related technology and, unless clearly defined otherwise, are not construed to be ideally or excessively formal.

In the following descriptions, the same reference numerals refer to the same elements, and unnecessary redundant descriptions and descriptions of the well-known art will be omitted.

In the embodiments, the terms ‘communication’, ‘communication network’ and ‘network’ may be used synonymously. The above three terms refer to wired and wireless near-field and wide-area data transceiving networks through which a user equipment, terminals of other users, and a download server may transmit and receive files.

Below, exemplary embodiments will be described in detail with reference to the accompanying drawings.

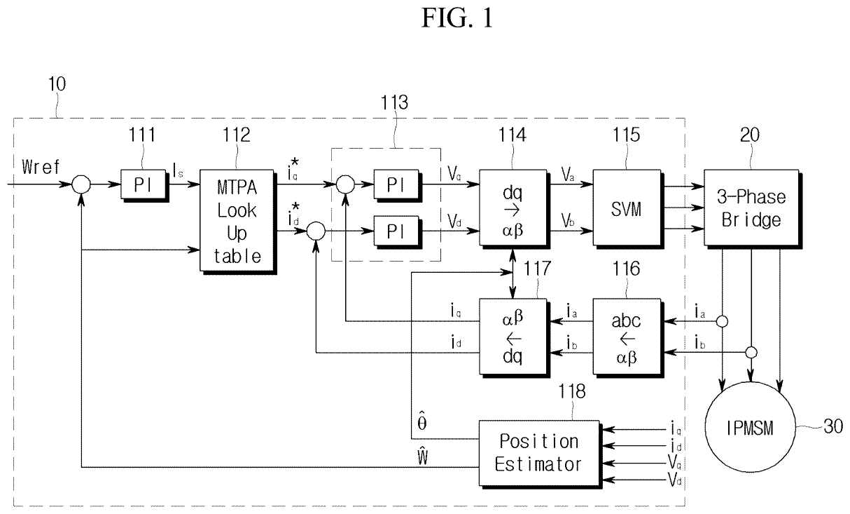

FIG. 1 is a block diagram showing the configuration of an inverter control device according to an embodiment.

Referring to FIG. 1, an inverter control device 10 may be connected to an inverter 20 and control the speed of a motor 30 connected to the inverter 20. The inverter control device 10 may control the motor 30 based on speed feedback while the motor 30 is operating.

The inverter control device 10 may output a current command to reduce a speed error between a reference speed W_{ref} and a motor speed Ŵ estimated by a motor speed estimation unit 118. The output of the current command may increase or decrease in size from a previous current command according to the sign or direction of the speed error. Further, the inverter control device 10 may adjust the output of the current command for maximum torque per ampere (MTPA) control and/or field-weakening control.

The inverter control device 10 may include a speed controller 111, a current command generator 112, a current PI controller 113, a voltage coordinate converter 114, a space vector modulator 115, and a first current coordinate converter 116, a second current coordinate converter 117, and a motor speed estimation unit 118.

The speed controller 111 may output a speed control signal Iₛ by proportioning and integrating a reference speed input from the outside and an error signal of an estimated motor speed from the motor speed estimation unit 118. The speed control signal Iₛ may be transmitted to the current command generator 112. The speed controller 111 may also be referred to as a speed proportional-integral (PI) controller.

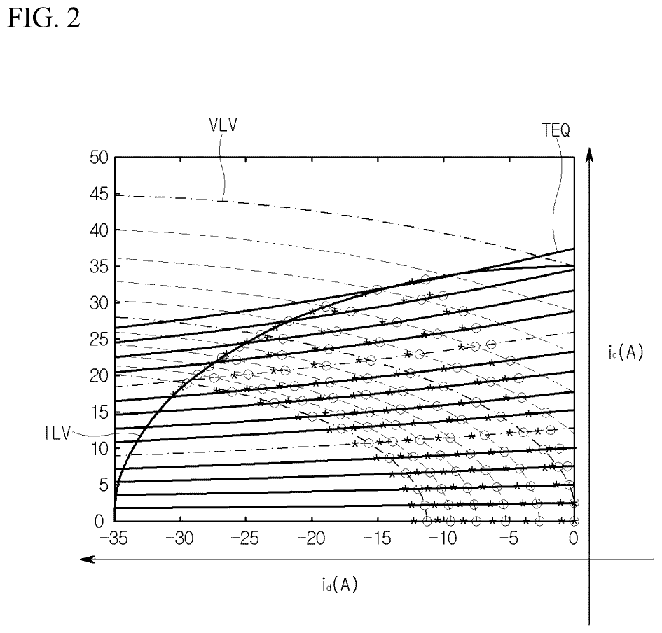

The current command generator 112 may output the current command for controlling the motor speed. The current command generator 112 may generate the current command corresponding to the estimated motor speed Ŵ and the speed control signal Iₛ of the speed controller 111 based on a current command lookup table. The current command generated by the current command generator 112 may include the current command for the MTPA control and the current command for the field-weakening control. Detailed operations of the current command generator 112 will be described later with reference to FIGS. 2 to 4.

The current PI controller 113 may include a d-axis current PI controller 113 and a q-axis current PI controller 113. The d-axis current PI controller 113 may output a d-axis voltage command v_{d} based on the output signal for the d-axis current of the second current coordinate converter 117 and a d-axis current command i*_{d} from the current command generator 112. The q-axis current PI controller 113 may output a q-axis voltage command vq based on the output signal for the q-axis current of the second current coordinate converter 117 and a q-axis current command i*_{q} from the current command generator 112. The d-axis and q-axis voltage commands v_{d} and v_{q} may be transmitted to the voltage coordinate converter 114.

The voltage coordinate converter 114 converts the d-axis and q-axis voltage commands v_{d} and v_{q} output from the current PI controller 113 into alpha-axis and beta-axis voltage commands v_{α} and v_{β} and transmits the alpha-axis and beta-axis voltage commands v_{α} and v_{β} to the space vector modulator 115.

The space vector modulator 115 modulates the two voltage commands v_{α} and v_{β} from the voltage coordinate converter 114 into a space vector, and controls the operations of the inverter 20 based on the modulated output signal. The space vector modulator 115 may project a reference vectors of 3 phases (ABC) on the output side to an orthogonal alpha-beta plane, select switching vectors to control the reference vector during one switching cycle, simply calculate a state maintenance time of all the selected switching vectors by using trigonometric functions, arrange all the selected switching vectors in order, and output the arranged switching signals of one cycle to the inverter 20.

The inverter 20 may be configured so that a plurality of power semiconductor switching elements can form a 3-phase bridge circuit, and a 3-phase output terminal of an inverter circuit is connected to the 3-phase terminal of the motor 30.

The motor 30 may be an interior permanent magnet synchronous motor (IPMSM).

The first current coordinate converter 116 may convert two-phase currents ia and is of among three-phases (ABC) currents supplied from the inverter 20 to the motor 30 into the alpha axis and beta axis currents i_{α} and i_{β}.

The second current coordinate converter 117 converts the alpha axis and beta axis currents i_{α} and i_{β} to the d-axis and q-axis currents i_{d} and i_{q}.

The motor speed estimation unit 118 may estimate the speed of the motor, and output the estimated motor speed. The estimated motor speed may be a rotor speed calculated based on the electrical angle. The motor speed estimation unit 118 may calculate the position \hat{θ} of a rotor of the motor 30 and the speed Ŵ of a rotor based on the d-axis and q-axis voltage commands v_{d} and V_{q} output from the current PI controller 113 for the speed control of the motor 30, and the d-axis and q-axis current i_{d} and i_{q} obtained by converting the two-phase currents among the three-phase currents supplied to the motor 30 through the first and second current coordinate converters 116 and 117.

A first output signal of the motor speed estimation unit 118 for the position \hat{θ} of the rotor shaft may be transmitted to each of the voltage coordinate converter 114 and the second current coordinate converter 117. A second output signal of the motor speed estimation unit 118 for the speed Ŵ of the rotor may be combined with an input signal for the reference speed W_{ref} from the outside and input to the speed controller 111. The second output signal of the motor speed estimation unit 118 for the speed Ŵ of the rotor may be input to the current command generator 112.

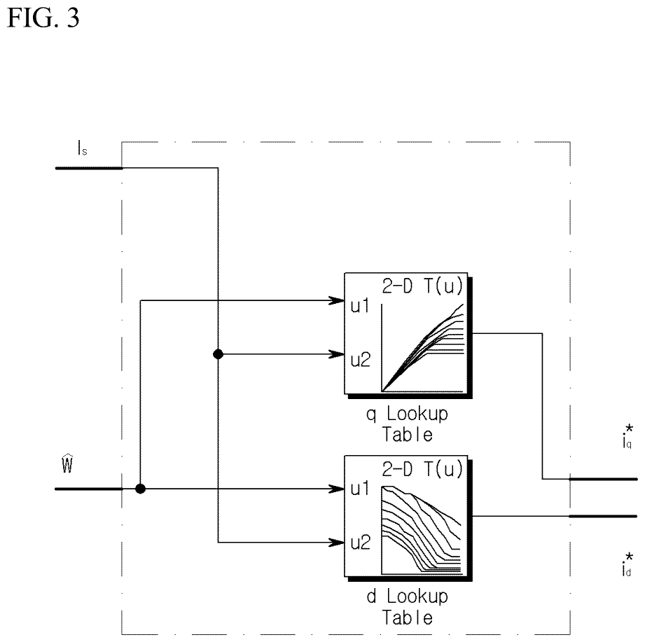

FIG. 2 is a diagram showing the MTPA lookup table according to an embodiment. FIG. 3 is a diagram showing the current command generator according to an embodiment.

Conventionally, the d-axis and q-axis current commands have been calculated using the MTPA calculation logic and the field-weakening calculation logic based on the output of the speed controller 111.

When the current command lookup table is not used, the current command may be calculated through complicated calculations and processes as follows.

The speed controller 111 outputs a speed control signal Iₛ. Then, the estimated motor speed Ŵ and the field-weakening area reference speed W_{base} are compared. When the estimated motor speed Ŵ is slower than the field-weakening area reference speed W_{base}, the d-axis current command i_{d2} and the q-axis current command i_{q2} for constant torque area control are calculated by the following Equation 1 and Equation 2. When the estimated motor speed Ŵ is faster than the field-weakening area reference speed W_{base}, the d-axis current command i_{d2} and the q-axis current command i_{q2} for the field-weakening area control are calculated by the following Equation 3 and Equation 4.

$${i}_{d 1} = \frac{ϕ}{4 ( {L}_{q} - {L}_{d} )} - \sqrt{\frac{{ϕ}^{2}}{16 {( {L}_{q} - {L}_{d} )}^{2}} + \frac{\text{?}}{2}} \qquad Equation 1$$

$${i}_{q 1} = \sqrt{\text{?} - {i}_{d 1}^{2}} \qquad Equation 2$$

$${i}_{d 2} = \frac{{L}_{d} ϕ - \sqrt{{( ϕ {L}_{q} )}^{2} + ( {L}_{q}^{2} - {L}_{d}^{2} ) ( {( {L}_{q} {I}_{max} )}^{2} - {( \frac{\text{?}}{\text{?}} )}^{2} )}}{{L}_{q}^{2} - {L}_{d}^{2}} \qquad Equation 3$$

$${i}_{q 2} = \sqrt{{I}_{max}^{2} - {i}_{d 2}^{2}} \qquad Equation 4$$

$$\text{?} \text{indicates text missing or illegible when filed}$$

In the Equations 1 to 4, Iₛ is the output (speed control signal) of the speed controller 111, Ŵ is an estimated motor speed, W_{base} is a field-weakening area reference speed, La is d-axis inductance, and L_{q} is q-axis inductance, Φ is motor magnetic flux, Iₘₐₓ is a current limit, Vₒₘ is a voltage limit, v_{d} is a d-axis voltage command, and vq is a q-axis voltage command.

According to the disclosure, the current command lookup table is used to calculate the d-axis current command i*_{d} and the q-axis current command i*_{q} based on the output from the speed controller 111 and the estimated motor speed. Accordingly, the current command may be generated without complicated calculations in the constant torque area and the field-weakening area.

Referring to FIG. 2, the current command generator 112 may generate the current command lookup table and store the generated current command lookup table. According to an embodiment, the current command generator 112 may include a memory to store the current command lookup table. According to some embodiments, the current command generator 112 may receive the current command lookup table from the outside.

The current command lookup table may be calculated by the current limit value, voltage limit value, and torque equation of the motor 30 based on the Equations 5 to 7. The current command lookup table may be expressed as the graph as shown in FIG. 2.

$${{i}_{d}^{*}}^{2} + {{i}_{q}^{*}}^{2} \leq {I}_{max}^{2} \qquad Equation 5$$

$${v}_{d}^{2} + {v}_{q}^{2} \leq {V}_{om}^{2} \qquad Equation 6$$

$$T = \frac{3}{2} \frac{P}{2} \{ ϕ {i}_{q}^{*} + ( {L}_{q} - {L}_{d} ) {i}_{d}^{*} {i}_{q}^{*} \} \qquad Equation 7$$

In Equations 5 to 7, L_{d} is d-axis inductance, L_{q} is q-axis inductance, Φ is motor magnetic flux, Iₘₐₓ is the current limit, Vₒₘ is voltage limit, i*_{d} is a d-axis current command, i*_{q} is a q-axis current command, v_{d} is a d-axis voltage command, V_{q} is a q-axis voltage command, and P is power.

In FIG. 2, the intersections between the torque equation TEQ and the voltage limit value VLV within the current limit value ILV are marked with ‘∘’. According to an embodiment, the current command generator 112 may store the values of the d-axis current command i*_{d} and q-axis current command i*_{q} corresponding to the points marked with ‘∘’ in the lookup table. According to some embodiments, the current command generator 112 may store the values of the d-axis current command i*_{d} and q-axis current command i*_{q} corresponding to the points marked with ‘*’ of FIG. 2 in the lookup table. The point marked with ‘*’ refers to a point offset by a predetermined value from the point marked with ‘∘’, which is a point where the value of the d-axis current command i*_{d} in the field-weakening area is shifted in a negative direction (i.e., the left direction of FIG. 2) than the point marked with ‘∘’ adjacent thereto to further increase a target speed under specific load conditions. According to some embodiments, the current command generator 112 may store the values of the d-axis current command i*_{d} and q-axis current command i*_{q} corresponding to the points marked with ‘∘’ and ‘*’ in the lookup table.

Referring to FIG. 3, the current command lookup table may include the d-axis current command lookup table and the q-axis current command lookup table. The current command generator 112 may generate and store the d-axis current command lookup table and the q-axis current command lookup table, based on the current command lookup table. According to an embodiment, the current command generator 112 may include a memory to store the d-axis current command lookup table and the q-axis current command lookup table. According to some embodiments, the current command generator 112 may receive the d-axis current command lookup table and the q-axis current command lookup table from the outside.

The d-axis current command lookup table and q-axis current command lookup table may be generated as n by m matrix tables of two-dimensional arrays. Here, n may be a value from 0 to a rated speed, and m may be a value from 0 to a current limit value Iₘₐₓ.

The current command generator 112 may generate the d-axis current command i*_{d} by inputting the speed control signal Iₛ and the estimated motor speed Ŵ to the d-axis current command lookup table. The current command generator 112 may generate the q-axis current command i*_{q} by inputting the speed control signal Iₛ and the estimated motor speed Ŵ to the q-axis current command lookup table. The generated d-axis current command i*_{d} and q-axis current command i*_{q} may be transmitted to the current PI controller 113.

The inverter control device 10 according to an embodiment may use the lookup table to generate the current command without complicated calculations in the constant torque area and the field-weakening area. Accordingly, the calculation speed required in designing the inverter control device 10 may be lowered, and an appropriate current command may be generated using fewer software resources. Further, the control logic may be simplified, and production costs may be reduced because a microcontroller unit (MCU) or the like having high processing capacity is not required.

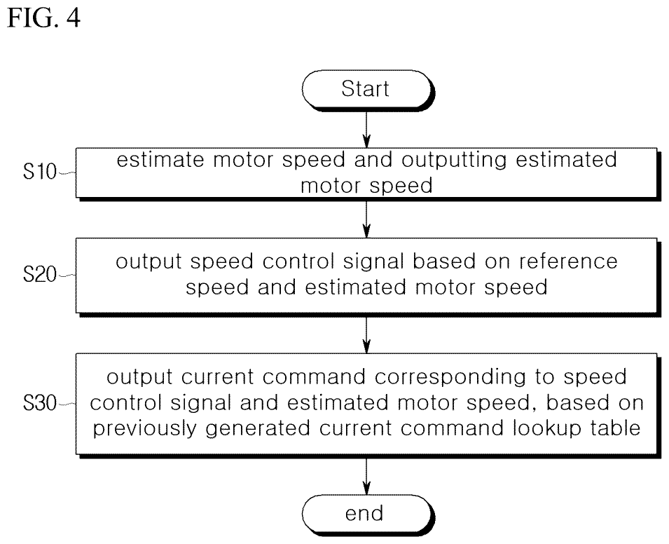

FIG. 4 is a flow chart showing the inverter control method according to an embodiment.

The following inverter control method may be performed by the inverter control device 10.

The inverter control method according to an embodiment includes steps of estimating a motor speed and outputting the estimated motor speed Ŵ (S10), outputting a speed control signal Iₛ based on the reference speed W_{ref} and the estimated motor speed Ŵ (S20), and outputting a current command corresponding to the speed control signal Iₛ and the estimated motor speed V based on the previously generated current command lookup table (S30).

The inverter control method is not limited to the foregoing method, and may exclude at least some of the foregoing steps or may further include at least another step based on the descriptions of this specification.

In step S10, the inverter control device 10 may estimate the speed of the motor and output the estimated motor speed Ŵ. The estimated motor speed Ŵ may be the speed of the rotor calculated based on the electrical angle.

The inverter control method may further include a step of generating the lookup table by the inverter control device 10. The inverter control device 10 may generate the lookup table based on the current limit value, voltage limit value, and torque equation of the motor.

The step of generating the lookup table may include a step of generating a d-axis current command lookup table and a q-axis current command lookup table based on the current command lookup table by the inverter control device 10.

In step S20, the inverter control device 10 may output a speed control signal Iₛ based on the reference speed W_{ref} and the estimated motor speed Ŵ.

In step S30, the inverter control device 10 may output the current command corresponding to the speed control signal Iₛ and the estimated motor speed Ŵ based on the previously generated current command lookup table. The current command may include the current command for the MTPA control and the current command for the field-weakening control.

The step S30 may further include a step of, by the inverter control device 10, generating and outputting the d-axis current command i*_{d} by inputting the speed control signal Iₛ and the estimated motor speed W̅ to the d-axis current command lookup table, and generating and outputting the q-axis current command i*_{q} by inputting the speed control signal Iₛ and the estimated motor speed Ŵ to the q-axis current command lookup table.

The inverter control method according to an embodiment may use the lookup table to generate the current command without complicated calculations in the constant torque area and the field-weakening area. Accordingly, the calculation speed required in designing the inverter control device 10 may be lowered, and an appropriate current command may be generated using fewer software resources. Further, the control logic may be simplified, and production costs may be reduced because a microcontroller unit (MCU) or the like having high processing capacity is not required.

According to embodiments, there are provided an inverter control device and an inverter control method, which do not require high calculation speed.

According to embodiments, there are provided an inverter control device and an inverter control method, which use fewer software resources.

According to embodiments, there are provided an inverter control device and an inverter control method, which have low manufacturing costs.

According to embodiments, there are provided an inverter control device and an inverter control method, which have simple control logic.

The effects according to the embodiments are not limited to the foregoing descriptions, and more various effects are involved in this specification.

Although a few embodiments of the disclosure have been described above with reference to the accompanying drawings, it will be understood by a person having ordinary knowledge in the art to which the disclosure pertains that the disclosure may be implemented in other specific forms without departing from the technical idea or essential features thereof. Accordingly, the foregoing embodiments should be construed as illustrative and not restrictive in all aspects.

What is claimed is:

1. An inverter control device for controlling a motor based on speed feedback while the motor is operating, the inverter control device comprising:
a motor speed estimation unit configured to estimate a speed of the motor and output an estimated motor speed;
a speed controller configured to output a speed control signal based on a reference speed and the estimated motor speed; and
a current command generator configured to output a current command corresponding to the speed control signal and the estimated motor speed, based on a previously generated current command lookup table.

2. The inverter control device of claim 1, wherein the current command generator is further configured to generate the current command lookup table, comprising current command values for maximum torque per ampere (MTPA) control, based on a current limit value, a voltage limit value, and a torque equation of the motor.

3. The inverter control device of claim 2, wherein the current command lookup table comprises a d-axis current command lookup table and a q-axis current command lookup table.

4. The inverter control device of claim 3, wherein the d-axis current command lookup table and the q-axis current command lookup table comprise current command values, which are added offset to the current command values for MTPA control, for field-weakening control.

5. The inverter control device of claim 3, wherein the current command generator is further configured to output a d-axis current command based on the d-axis current command lookup table and a q-axis current command based on the q-axis current command lookup table.

6. The inverter control device of claim 5, further comprising:
a first current coordinate converter configured to convert three-phase currents supplied from an inverter to the motor into an alpha axis current and a beta axis current;
a second current coordinate converter configured to convert the alpha axis current and the beta axis current to a d-axis current and a q-axis current;
a current PI controller configured to generate a d-axis voltage command based on the d-axis current command and the d-axis current and a q-axis voltage command based on the q-axis current command and the q-axis current;
a voltage coordinate converter configured to convert the d-axis voltage command and q-axis voltage command into an alpha-axis voltage command and a beta-axis voltage command; and
a space vector modulator configured to modulate the alpha-axis voltage command and the beta-axis voltage command into a space vector.

7. The inverter control device of claim 6, wherein the motor speed estimation unit is configured to estimate a rotor position and a rotor speed of the motor based on the d-axis voltage command, the q-axis voltage command, the d-axis current and the q-axis current.

8. The inverter control device of claim 7, wherein the rotor position is provided to the second current coordinate converter in order to be used for converting the alpha axis current and the beta axis current to the d-axis current and the q-axis current and wherein the rotor position is provided to the voltage coordinate converter in order to be used for converting the d-axis voltage command and q-axis voltage command into an alpha-axis voltage command and a beta-axis voltage command.

9. An inverter control method of an inverter control device comprising:
estimating a speed of a motor and outputting an estimated motor speed;
outputting a speed control signal based on a reference speed and the estimated motor speed; and
outputting a current command corresponding to the speed control signal and the estimated motor speed, based on a previously generated current command lookup table.

10. The inverter control method of claim 9, further comprising:
generating the current command lookup table, comprising current command values for maximum torque per ampere (MTPA) control, based on a current limit value, a voltage limit value, and a torque equation of the motor.

11. The inverter control method of claim 10, wherein the generating the current command lookup table comprises generating a d-axis current command lookup table and a q-axis current command lookup table.

12. The inverter control method of claim 11, wherein the d-axis current command lookup table and the q-axis current command lookup table comprise current command values, which are added offset to the current command values for MTPA control, for field-weakening control.

13. The inverter control method of claim 11, wherein the outputting the current command comprises outputting a d-axis current command based on the d-axis current command lookup table and a q-axis current command based on the q-axis current command lookup table.

14. The inverter control method of claim 13, further comprising:
converting three-phases currents supplied from the inverter to the motor into an alpha axis current and a beta axis current;
converting the alpha axis current and the beta axis current to a d-axis current and a q-axis current;
generating a d-axis voltage command based on the d-axis current command and the d-axis current and a q-axis voltage command based on the q-axis current command and the q-axis current;
converting the d-axis voltage command and q-axis voltage command into an alpha-axis voltage command and a beta-axis voltage command; and
modulating the alpha-axis voltage command and the beta-axis voltage command into a space vector.

15. The inverter control method of claim 14, wherein the estimating the speed of the motor comprises estimating a rotor position and a rotor speed of the motor based on the d-axis voltage command, the q-axis voltage command, the d-axis current and the q-axis current.

16. The inverter control method of claim 15, further comprising:
providing the rotor position to a second current coordinate converter in order to be used for converting the alpha axis current and the beta axis current to the d-axis current and the q-axis current, and
providing the rotor position to a voltage coordinate converter in order to be used for converting the d-axis voltage command and the q-axis voltage command into the alpha-axis voltage command and the beta-axis voltage command.
